(19) United States
(12) Patent Application Publication
(10) Pub. No.: US 2015/0366291 A1
(43) Pub. Date: Dec. 24, 2015

(54) METHOD FOR INJECTION MOULDING SAFETY FOOTWEAR

(71) Applicant: Genfoot Inc., Montreal (CA)

(72) Inventors: Gordon Cook, Montreal (CA); Joseph Bichai, Dollard-des-Ormeaux (CA)

(21) Appl. No.: 14/742,281

(22) Filed: Jun. 17, 2015

(30) Foreign Application Priority Data
Jun. 19, 2014 (CA) 2854683

(51) Int. Cl. A43B 7/32; B29D 35/06; A43B 23/04; B29D 35/00; A43B 1/14; A43B 13/42

(52) U.S. Cl. CPC A43B 7/32; A43B 1/14; A43B 13/42; A43B 23/042; B29D 35/0036; B29D 35/061; B29K 2101/12

(57) ABSTRACT

A method is provided for injection moulding a footwear product having a non-metallic insole integrally formed between a sole and upper of the product. A sole cavity formed between a sole plate and cover plate tightly closed together is injected to form a sole, wherein the cover plate is configured to establish an insole sole cavity directly above and adjacent to the sole cavity, the insole cavity configured to receive and hold a non-metallic insole over the sole. The cover plate is removed to expose the sole and the insole cavity there over. A non-metallic insole is inserted in the insole cavity whereby the non-metallic insole is held over the sole by the insole cavity. An upper cavity of an upper mould is injected to fill the upper cavity and form an upper attached to the sole, the upper mould comprising shells tightly closed together around a last over the sole plate when comprising the hardened injected sole therein and the non-metallic insole held in the insole cavity to prevent movement of the non-metallic insole during the injecting of the injection material into the upper cavity, the last having an exterior surface configured to correspond to the shape of an interior surface of the footwear product, and the upper cavity formed between the shells and the last.

### FIELD OF THE INVENTION

The invention is in the field of manufacturing footwear and, in particular, pertains to an improved method for injection moulding safety footwear having a non-metallic insole.

### BACKGROUND

Safety footwear is conventionally made with metallic safety insoles embedded into the sole of the footwear for the purpose of resisting penetration of foreign objects through the sole which may cause injury to the wearer's foot. More recently, however, non-metallic safety insoles have become available and this type of safety insole is considered superior to metallic safety insoles because it does not conduct electricity and, advantageously in northern climates, also does not conduct extreme cold temperatures.

Disadvantageously, however, the manufacture of safety footwear having non-metallic safety insoles is currently done by means of the labour intensive lasted process of forming an upper of the footwear product by cutting selected material pieces, which may be leather and/or fabric, and then assembling them over the last and sewing them together to form the upper. Thereafter a sole with a non-metallic safety insole is cemented to the finished upper piece.

The injection moulding process provides many advantages over that conventional lasted process for making footwear. For this process, a last is sandwiched between two shell plates, referred to as shells, of an upper mould which, together with the last, are configured to establish an upper injection cavity when closed together over the last. The last functions as a three dimensional model (pattern) to define the injection cavity between the outer surface of the last and inner surfaces of the shells. The exterior surface of the last is configured to mirror the size and shape of the interior surface of the intended footwear upper piece. An injection material is injected under high pressure into the injection cavity and, when hardened, forms the upper. The sole is similarly moulded between two plates of a sole mould, either via the same injection cycle or a separate injection cycle. Both of the injection moulds and the last used in this process are made of a durable, high quality metal such as aluminum or steel.

Currently, only safety footwear having metallic safety insoles are sometimes made using an injection moulding process. This process is not used, however, to make safety footwear having non-metallic safety insoles because it is necessary to securely fix the insole into position in the injection mould so that it doesn't move during the high pressure injection step. For metallic insoles this is done effectively using magnets to secure a metallic insole to the metallic last within the mould. Since magnets are non-operable on non-metallic materials this known securing means cannot be used for non-metallic insoles and there is a need for a method of injection moulding safety footwear having non-metallic insoles.

### SUMMARY OF THE INVENTION

In accordance with the present invention a method is provided for injection moulding a footwear product (e.g. a safety boot) having a non-metallic insole (e.g. a safety insole). Flowable sole injection material is injected under pressure into a sole cavity of a sole mould to fill the sole cavity and form a sole upon hardening of the sole injection material.

The sole mould comprises a sole plate and cover plate tightly closed together wherein the cover plate is configured to establish between the tightly closed sole plate and cover plate an insole cavity directly above and adjacent to the sole cavity. The insole cavity is configured to receive and hold a non-metallic insole over the sole. The cover plate is removed to expose the sole and the insole cavity there over. A non-metallic insole is inserted in the insole cavity whereby the non-metallic insole is held over the sole by the insole cavity. Flowable upper injection material is injected under pressure into an upper cavity of an upper mould to fill the upper cavity and form an upper attached to the sole upon hardening of the upper injection material.

The upper mould comprises shells tightly closed together around a last over the sole plate when comprising the hardened injected sole therein and the non-metallic insole held in the insole cavity to prevent movement of the non-metallic insole during the injecting of the injection material into the upper cavity. The last has an exterior surface configured to correspond to the shape of an interior surface of the footwear product. The upper cavity is formed between the shells and the last.

The sole and upper injection materials may be molten thermoplastic or thermosetting materials (e.g. a polymer material) and hardened by cooling. Alternatively, the sole and upper injection materials may be curable materials and hardened by curing.

Preferably, the cover plate comprises an undercut section angled inwardly of the vertical direction at an angle (⊖) from each of a front edge and a back edge the cover plate, wherein the size and shape of each undercut section and the angle (⊖) are chosen to optimize the fit of the non-metallic insole in the insole cavity. The non-metallic insole may snap-fit into the insole cavity.

Also provided by the invention is a footwear product made by the aforesaid method, such as a boot or a shoe.

### BRIEF DESCRIPTION OF THE DRAWINGS

The invention is described in detail below with reference to the following drawings.

FIG. 1 is a sectional side view of a footwear product having a non-metallic insole after having been injection moulded in accordance with the present invention.

FIGS. 2A and 2B are sectional side views of a sole mould, FIG. 2A being the sole plate and FIG. 2B being the cover plate.

FIG. 3 is a sectional side view of the sole plate of FIG. 2A after it has been used to injection mould a sole, showing the injected sole in the mould and, by dotted lines, a cavity configured to receive a non-metallic insole and hold it securely against the top of the injected sole.

FIG. 4 is a sectional back view of the upper and sole moulds after both a sole and an upper of a footwear product have been injected, with a non-metallic insole having been inserted over the injected sole prior to closing the upper mould shells over the sole to inject the upper.

### DETAILED DESCRIPTION

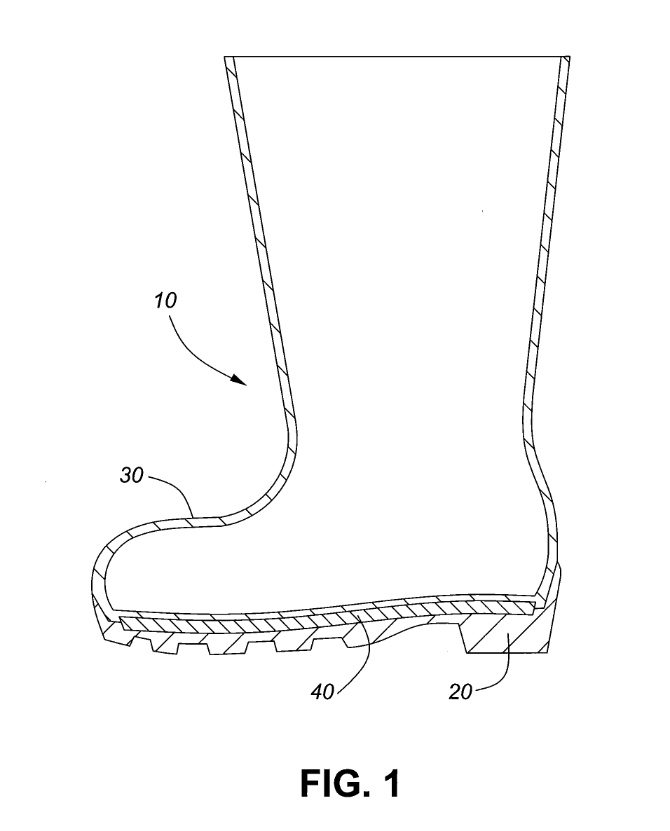

The invention provides a method for injection moulding footwear having integrated non-metallic insoles. A sole mould forms a sole 20 with an insole cavity there over into which the non-metallic insole 40 is inserted for a snap-fit. A last is used within an upper mould to form the upper 30 of the footwear product over the sole 20 and non-metallic insole 40. A predetermined flowable injection material is selected as appropriate for the application. Thermoplastic and thermosetting polymer materials are commonly used for this. Curable materials formed by mixing prior to each injection step may also be suitable for some applications. As illustrated by FIG. 1, the finished footwear product 10 comprises an upper 30 and a sole 20 with an integral non-metallic insole 40 between the upper 30 and sole 20.

The upper mould comprises two shells 80 and also uses the sole plate 50 of the sole mould. The sole mould comprises a sole plate 50 and a cover plate 60.

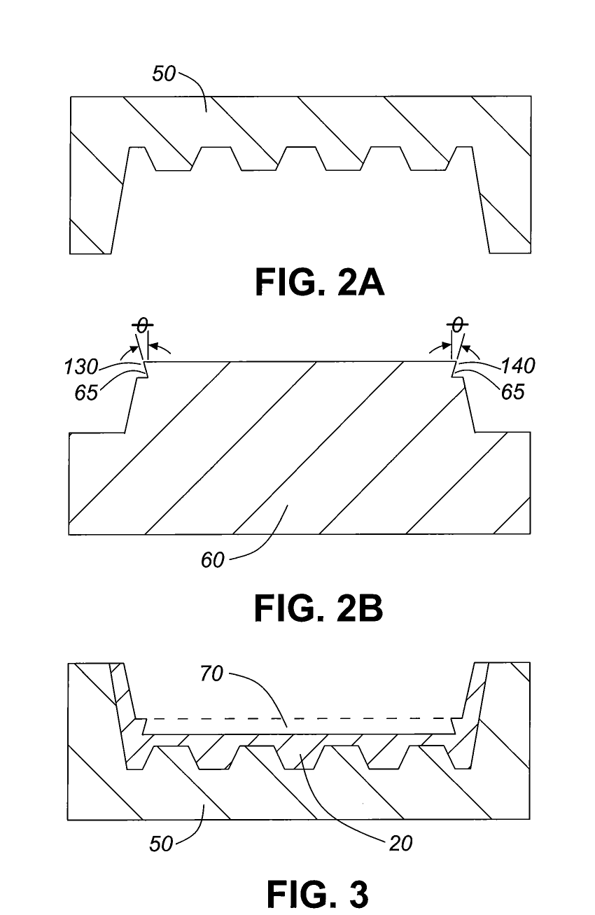

The sole mould of an exemplary embodiment is illustrated by FIGS. 2A and 2B. The sole mould is advantageously configured to establish an insole cavity 70 over the sole 20 to be injected in the mould. The insole cavity 70 established by the sole mould is for receiving a non-metallic safety insole 40 that is inserted after injection of the sole 20. The non-metallic insole 40 snap fits into the cavity 70 and securely held in position in the insole cavity 70 adjacent the sole 20 by an operator. As shown, the sole mould includes a sole plate 50 (FIG. 1A) and a cover plate 60 (FIG. 2B) which are tightly closed together in conventional manner to injection mould the sole 20. When tightly closed together the sole plate 50 and cover plate 60 form both a sole cavity having the intended sole configuration for the particular footwear item to be manufactured and an insole cavity 70 directly above and adjacent to the sole.

The configuration of the insole cavity 70 formed by the sole mould is specifically designed to receive with a snap-fit, and securely hold, a non-metallic insole 40 over the sole 20 after the sole 20 has been injection moulded. The insole cavity 70 is established by undercut sections 65 extending along the inner front 130 and back 140 edges of the cover plate 60. From each of the front 130 and back 140 edges of the cover plate 60, an undercut section 65 is angled inwardly of the vertical direction at an angle (⊖). The size and shape of each undercut section and the angle (⊖) are chosen to optimize the fit of the non-metallic insole in the insole cavity. They may be chosen so the insole 40 snap-fits into the cavity 70. Once the insole 40 has been inserted into the cavity 70 it is held in position above and adjacent to the sole 20 and prevented from moving during the step of injecting the upper 30.

To injection mould the sole 20 the sole plate 50 and cover plate 60 are tightly closed and an injector of an injection moulding machine injects the flowable injection material into a sole cavity established between the mould plates. The injection material injected in the mould is then hardened (e.g. by cooling for a thermoplastic injection material or curing for a curable injection material) and forms the sole 20. The cover plate 60 is opened (separated from the sole plate 50)) and an operator inserts a non-metallic insole 40 into the insole cavity 70 so that it is held against the top surface of the sole 20.

The upper 30 of the boot 10 is then injection moulded over the sole 20, non-metallic insole 40 and sole plate 50 using an upper mould comprising shells 80 and a last 90 positioned within the upper mould. The upper mould shells 80 and sole mould plates 50, 60 are comprised of a hard metal such has hardened aluminum or steel for high durability.

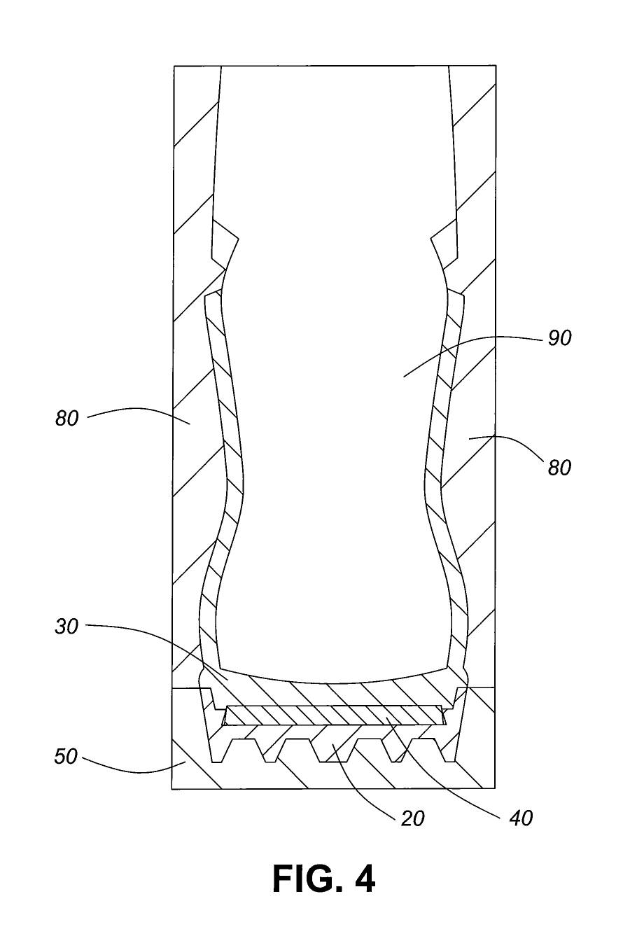

As illustrated by FIG. 4, the last 90 functions as a three dimensional model of a foot to form the upper 30 and is made of a hard metal, usually of hardened aluminum or steel for high durability. The exterior surface of the last 90 is configured to mirror (i.e. correspond to) the size and shape of the interior surface of the item of footwear that is to be made. When the upper mould is closed over the last 90 the last 90 is encased between the upper mould shells 80 and the sole plate 50 with injected sole 20 and non-metallic insole 40 securely positioned there over, and forms an upper cavity into which injection material is injected under pressure to fill the cavity and form the upper 30.

For the exemplary embodiment a boot, such as a safety work boot, is illustrated;

however, it is to be understood that the invention is not limited to safety-type footwear or any particular type of footwear and also provides other types of injection moulded footwear having integral non-metallic insoles, including boots of all types and shoes.

The details of the illustrated embodiment may be varied as considered expedient to a person skilled in the art and are not to be considered essential to the invention by reason only of inclusion in the preferred embodiment. Rather, the invention is defined by the appended claims.

What is claimed is:

1. A method for injection moulding a footwear product having a non-metallic insole comprising:
(a) injecting under pressure flowable sole injection material into a sole cavity of a sole mould to fill the sole cavity and form a sole upon hardening of the sole injection material, the sole mould comprising a sole plate and cover plate tightly closed together wherein the cover plate is configured to establish between the tightly closed sole plate and cover plate an insole sole cavity directly above and adjacent to the sole cavity, the insole cavity configured to receive and hold a non-metallic insole over the sole;
(b) removing the cover plate and exposing the sole and the insole cavity there over;
(c) inserting a non-metallic insole in the insole cavity whereby the non-metallic insole is held over the sole by the insole cavity; and, (d) injecting under pressure flowable upper injection material into an upper cavity of an upper mould to fill the upper cavity and form an upper attached to the sole upon hardening of the upper injection material, the upper mould comprising shells tightly closed together around a last over the sole plate when comprising the hardened injected sole therein and the non-metallic insole held in the insole cavity to prevent movement of the non-metallic insole during the injecting of the injection material into the upper cavity, the last having an exterior surface configured to correspond to the shape of an interior surface of the footwear product, and the upper cavity formed between the shells and the last.

2. A method according to claim 1 wherein the sole and upper injection materials are comprised of molten thermoplastic and the hardening of the sole and upper injection materials is by cooling the molten thermoplastic.

3. A method according to claim 1 wherein the sole and upper injection materials are curable and the hardening of the sole and upper injection materials is by curing.

4. A method according to claim 1 wherein the non-metallic insole is a safety insole.

5. A method according to claim 4 wherein the footwear product is a safety boot.

6. A method according to claim 1 wherein the cover plate comprises an undercut section angled inwardly of the vertical direction at an angle (e) from each of a front edge and a back edge the cover plate, wherein the size and shape of each undercut section and the angle (⊖) are chosen to optimize the fit of the non-metallic insole in the insole cavity.

7. A method according to claim 6 wherein the size and shape of each undercut section and the angle (⊖) are chosen so the non-metallic insole snap-fits into the insole cavity.

8. A method according to claim 1 wherein the sole injection material is a polymer material.

9. A method according to claim 1 wherein the upper injection material is a polymer material.

10. A footwear product made by the method of claim 1.

11. A footwear product according to claim 10 which is a boot or a shoe.
